(19) United States
(12) Patent Application Publication
(10) Pub. No.: US 2026/0338339 A1
(43) Pub. Date: Oct. 29, 2026

(54) LIGHT-EMITTING UNIT FOR A LIGHT-EMITTING MODULE FOR A VEHICLE

(71) Applicant: VALEO VISION, Bobigny (FR)

(72) Inventors: Sergio DONOSO, Martos (ES); Carlos-Rafael MARCOS, Martos (ES); Sylvain PRIME, Bobigny (FR); Yves GROMFELD, Bobigny (FR)

(73) Assignee: VALEO VISION, Bobigny (FR)

(21) Appl. No.: 18/998,862

(22) PCT Filed: Jul. 28, 2023
(86) PCT No.: PCT/EP2023/070997

§ 371 Date: Jan. 27, 2025

(30) Foreign Application Priority Data
Jul. 28, 2022 (FR) FR2207766

(51) Int. Cl. F21S 41/25; F21S 41/30

(52) U.S. Cl. CPC F21S 41/25; F21S 41/30

(57) ABSTRACT

The present invention relates to a luminous unit of a luminous module of a vehicle. The luminous unit includes a first luminous subassembly including a first light source configured to emit a plurality of first light rays, and a first collector, a second luminous subassembly including a second light source configured to emit a plurality of second light rays, and a second collector, an optical projection system including an optical axis parallel to a longitudinal direction. The first collector and the second collector are offset with respect to one another along the longitudinal direction, the first collector including a rear end edge, the rear end edge being arranged between the projection lens and an optical focus of the projection lens.

### TECHNICAL FIELD

The present invention relates to the field of automotive vehicle luminous modules, and in particular lighting and/or signaling modules, and relates more particularly to a luminous unit incorporated into such luminous modules.

### BACKGROUND OF THE INVENTION

The field of luminous lighting for automotive vehicles is subject to regulations that require each automotive vehicle to be able to carry out lighting functions that comply with specific safety standards. More particularly, the automotive vehicle is equipped with one or more luminous modules dedicated to carrying out each of these functions within each of these modules, at least one light source which is supplied with power in order to emit light rays which exit the luminous module through a lens configured to form a regulatory lighting or signaling light beam.

For reasons of space in particular, it is desirable to equip an automotive vehicle comprising a plurality of luminous modules, each of these luminous modules carrying out a lighting function, or advantageously at least two different lighting functions. Increasing the compactness of such luminous modules makes it possible in particular to limit the manufacturing costs on account of the reduction in electrical connections or raw materials.

However, making a luminous module more compact must not have a negative effect on the effectiveness and/or the uniformity of the light beams resulting from each of the lighting functions. By way of example, some light beams have to be projected so as to have a sharp upper horizontal cutoff and require particular attention to be paid to the structure of the corresponding luminous module.

### SUMMARY OF THE INVENTION

The present invention makes it possible to combine sharpness of the light beam formed and compactness of the luminous module by providing a luminous unit of a luminous module of an automotive vehicle, comprising:
a first luminous subassembly comprising at least a first light source configured to emit a plurality of first light rays and a first collector configured to collect and reflect the first light rays emitted by the first light source,
a second luminous subassembly comprising at least a second light source configured to emit a plurality of second light rays and a second collector configured to collect and reflect the second light rays emitted by the second light source, and
an optical projection system configured to project the first light rays reflected by the first collector and the second light rays reflected by the second collector, the optical projection system comprising an optical axis parallel to a longitudinal direction.

The luminous unit is noteworthy in that the first collector and the second collector are offset with respect to one another at least along the longitudinal direction such that the first collector is arranged between the second collector and the optical projection system, the first collector comprising a rear end edge arranged between the optical projection system and an optical focus of said optical projection system.

Two luminous subassemblies are thus combined in one luminous unit in order that the latter carries out a plurality of light functions. This thus makes it possible to combine several light functions within one and the same luminous module. The positioning of the optical focus of the optical projection system with respect to each of the collectors, and the positioning of the collectors with respect to one another, ensures the separate creation of the light beams resulting respectively from the first luminous subassembly and from the second luminous subassembly, and makes it possible to ensure the formation of a light beam with a sharp upper cutoff edge, by imaging of a rear end edge of the first collector forming the upper part of the light beam projected onto the road.

For each luminous subassembly, the light source is activated when the lighting function or one of the lighting functions in which it is involved is implemented. The light source thus emits a plurality of light rays mainly in the direction of the collector. The latter has a reflective surface facing the light source with which it is associated. In addition, the collector has a shape exhibiting symmetry of revolution, elliptical or parabolic, in order to reflect the light rays in the direction of the optical projection system, irrespective of the point of incidence of the light ray on the reflective surface. For example, the collector has a shape exhibiting symmetry of revolution, elliptical or parabolic, centered on the optical axis of the optical projection system.

The reflected light rays then propagate to the optical projection system, in particular by propagating along a propagation direction that is mainly longitudinal, parallel to the direction of the optical axis of the optical projection system. The optical projection system projects the light rays so as to form the light beam associated with the given lighting function.

The first collector and the second collector are offset with respect to one another along this same longitudinal direction, with a minimum offset such that the collectors take up as little space as possible in order to ensure the compactness of the luminous unit, and of the luminous module.

The longitudinal offset of the collectors with respect to one another is such that the first collector is closer to the optical projection system than the second collector. The rear end edge of the first collector therefore corresponds to the section of the first collector that is spatially closest to the second collector. There may be direct contact between the rear end of the first collector and the second collector, in particular to prevent light leaking between the collectors. A platform may in particular connect the rear end edge of the first collector and the second collector, and allow a more uniform transition between the light beams formed by the first luminous subassembly and the second luminous subassembly, by causing these beams to be superimposed on one another.

As has been mentioned, the optical focus of the optical projection system is disposed at or in a manner set back from the rear end edge of the first collector. Such positioning of the optical focus makes it possible to ensure sharpness of the cutoff edge of the first light beam projected by the first luminous subassembly, while allowing the formation of the second light beam output by the second luminous subassembly. It should be understood that, when the rear end edge does not have a straight shape perpendicular to the optical axis, but a curved profile, the optical focus is positioned at the same distance from the optical projection system as or at a greater distance therefrom than the projection onto the optical axis of the point of the rear end edge farthest away from the optical projection system is.

According to one feature of the invention, the optical projection system is formed by a projection lens. The projection lens may be part of a projection unit combining a plurality of projection lenses, each of which is inherent to a luminous unit when the luminous module combines a plurality of luminous units.

According to one feature of the invention, the optical projection system is formed by a projection mirror.

According to one feature of the invention, the rear end edge of the first collector is in contact with a front end edge of the second collector.

According to one feature of the invention, the optical focus of the optical projection system is disposed at a distance less than or equal to 10 mm from the rear end edge of the first collector.

According to one feature of the invention, the first collector and the second collector are offset with respect to one along a vertical direction perpendicular to the longitudinal direction. Since the second collector is arranged behind the first collector, the latter may potentially obstruct the propagation of the second light rays to the optical projection system. To remedy this obstruction, the second collector, in addition to being offset with respect to the first collector along the longitudinal direction, is also offset at least along the vertical direction. In particular, the second collector is closer to the printed circuit board than the first collector is. The difference in height between the two collectors ensures the propagation of the light rays from the two luminous subassemblies to the optical projection system, the latter needing to be large enough to project all of the light rays despite the offset along the vertical direction between the collectors.

According to one feature of the invention, the optical axis of the optical projection system passes substantially through the rear end edge of the first collector and intersects the second collector. The collectors are offset vertically with respect to one another such that the rear end edge of the first collector forms the lowest part of the first collector, or the one closest to the printed circuit board, and at least a part of the second collector extends lower, or closer to the printed circuit board, than the rear end edge of the first collector. In this context, the optical axis, and therefore the optical focus of the optical projection system, are disposed vertically at one end of the first collector and substantially at the center of the second collector.

According to one feature of the invention, the luminous unit comprises a printed circuit board bearing all of the first and second light sources. This single printed circuit board therefore bears at least the first light source and the second light source that were mentioned above. The printed circuit board is configured to make it possible to control the functioning of the light sources, for example following a manual command made by a user of the vehicle, and consequently to turn on or turn off one or the other of the light sources. Using only one printed circuit board for all of the light sources makes it possible to reduce the space requirement of the luminous unit, and therefore of the luminous module in which the luminous unit is incorporated. Furthermore, the use of a single printed circuit board makes it possible to limit the connections and the assembly compared with the use of a plurality of printed circuit boards.

According to one feature of the invention, the printed circuit board has an inclination of between 5° and 15° with respect to a plane perpendicular to the vertical direction. Such an inclination makes it possible to position the light sources closer to their respective collectors. This then generates reflection of a greater number of light rays and thus improves the intensity of the light beams exiting the optical projection system.

According to one feature of the invention, the first collector comprises at least two reflective cavities that are offset with respect to one along a transverse direction perpendicular to the longitudinal direction and to the vertical direction. Having two reflective cavities offset with respect to one another along the transverse direction makes it possible to extend the light beam of the first luminous subassembly along the transverse direction. Advantageously, in this configuration, the first luminous subassembly may comprise at least two light sources, with one light source per reflective cavity.

According to one feature of the invention, the rear end edge of the first collector is defined by the continuity of the rear end edges of each of the reflective cavities. The optical focus of the optical projection system is disposed at or in a manner set back from each of the points defining the rear end edges of the cavities of the first collector.

According to one feature of the invention, the two reflective cavities of the first collector are joined together by a joining zone parallel to the longitudinal direction. For example, the joining zone is aligned along the optical axis with respect to the vertical direction. In order to avoid optical interference between the collectors, the two reflective cavities are both offset along the transverse direction with respect to the second collector, in order that the second light rays can still propagate correctly despite the first collector.

According to one feature of the invention, the first luminous subassembly is configured to cooperate with the optical projection system in order to generate a first light beam with a cutoff edge formed by the imaging of the rear end edge of the first collector, and the second luminous subassembly is configured to cooperate with the optical projection system in order to generate a second light beam different than the first light beam, at least a part of which is situated above the cutoff edge. The cutoff edge forms an upper cutoff in the first light beam. The second light beam may in particular have a greater intensity than the first light beam.

As mentioned above, each luminous subassembly can carry out a lighting function that is inherent thereto. A plurality of lighting functions can therefore be carried out by a single luminous unit, and therefore within a single luminous module. In particular, in the context that has just been mentioned, the first luminous subassembly is capable of generating a light beam corresponding to a low beam, or to a portion of a low beam, that is to say with a sharp cutoff edge forming an upper cutoff in the first light beam, and which makes it possible in particular not to dazzle other road users, and the second luminous subassembly is capable of generating a light beam, at least a part of which is situated above the cutoff edge, and which may, for example, be superimposed on the first light beam in order to form a light beam of the high beam type, or be an intensification of a light beam, at the center thereof, in order to form a light beam of the high beam type.

The invention also covers a luminous module of a vehicle, comprising a luminous module as described above.

In particular, the invention covers a luminous module of a vehicle, comprising at least one luminous module as described above.

According to one feature of the invention, the luminous module comprises at least a first luminous unit and a second luminous unit, the first luminous unit being as described above. The plurality of luminous units therefore make it possible to further multiply the lighting functions within one and the same luminous module.

According to one feature of the invention, the second luminous unit comprises at least one additional luminous subassembly and an additional optical projection system. The additional luminous subassembly or subassemblies may carry out lighting functions different than the functions of the luminous subassemblies that are provided by the first luminous unit.

The additional optical projection system may be formed by an additional projection mirror or by an additional projection lens.

According to one feature of the invention, when the optical projection system of the first luminous unit is formed by a projection lens, the additional optical projection system may also be formed by a projection lens, referred to as additional projection lens. Where appropriate, the luminous module comprises a projection unit divided into a first portion delimiting the projection lens of the first luminous unit and a second portion delimiting the additional projection lens of the second luminous unit. In other words, the projection unit can be divided into a plurality of optical elements, including the projection lens of the first luminous unit and the additional projection lens of the second luminous unit, each of the optical elements being attached to a luminous unit that is inherent thereto. The features of each of the optical elements of the projection unit may vary depending on the objectives to be met by the light beams formed by each of the luminous units.

### BRIEF DESCRIPTION OF DRAWINGS

Further features and advantages of the invention will also become apparent both from the following description and from a number of exemplary embodiments given by way of nonlimiting indication with reference to the attached schematic drawings, in which:

FIG. 1 is a depiction of a luminous module according to the invention,

FIG. 2 shows the luminous module according to the invention in a perspective view revealing a projection lens, a printed circuit board and a plurality of collectors fastened to this printed circuit board,

FIG. 3 shows a top view of the luminous module, wherein only the collectors have been depicted, section planes IV-IV, V-V being shown,

FIG. 4 is a first view in cross section, on the section plane IV-IV in FIG. 3, of a luminous unit according to the invention that is incorporated within the luminous module, showing, by way of example, lines of light rays that are able to be reflected within the luminous unit according to the invention,

FIG. 5 is a second view in cross section, on the section plane V-V in FIG. 3, of the luminous unit in FIG. 4, showing, by way of example, lines of light rays that are able to be reflected within the luminous unit according to the invention,

FIG. 6 is a view in cross section of collectors of the luminous unit, on a section plane perpendicular to the optical axis of the projection lens associated with the luminous unit, and

FIG. 7 shows a luminous module according to a variant of the invention, revealing a projection mirror.

### DETAILED DESCRIPTION OF THE INVENTION

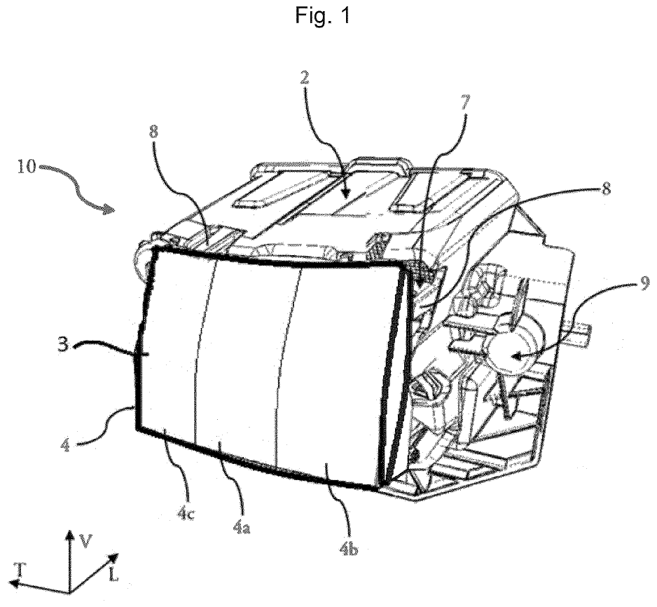

FIG. 1 is an overall view of a luminous module 10 according to the invention. The luminous module 10 may, for example, be incorporated into an automotive vehicle, for example into a headlamp of the automotive vehicle, in order to fulfill at least one lighting function when said vehicle is running. In this regard, the luminous module 10 may, in particular, be arranged at the front of the vehicle.

The luminous module 10 is housed in a mask 2. The luminous module is configured to carry out a plurality of light functions or at the very least to contribute to the emission of a plurality of lighting functions onto the road. The luminous module ensures the emission and the propagation of light rays until they pass through a projection unit 4.

As will be described in detail below, the luminous module comprises a plurality of luminous units that carry out one or more lighting functions, and in particular the luminous unit according to the invention.

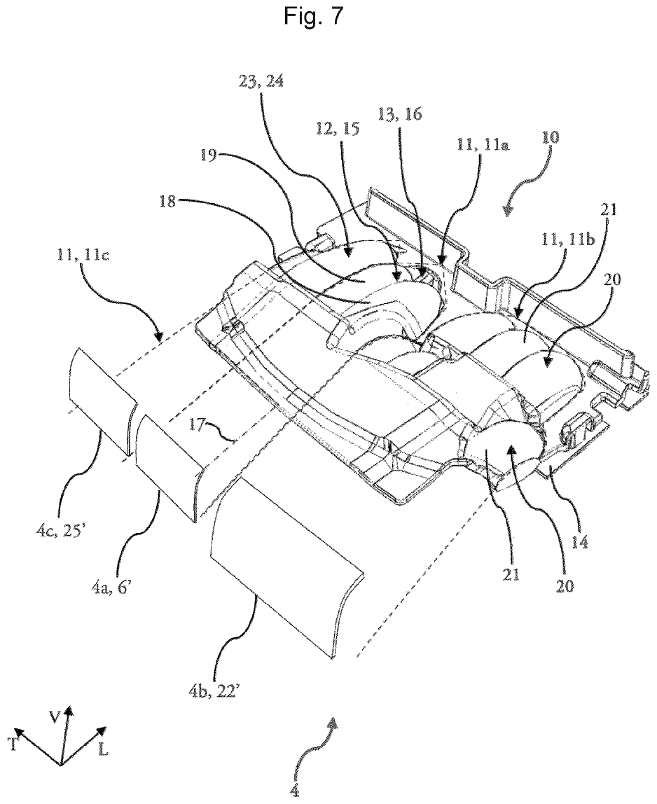

The projection unit 4 is divided into a plurality of portions 4a, 4b, 4c. In the example in FIG. 1, each luminous unit of the luminous module 10 comprises a projection lens. Each portion 4a, 4b, 4c is then formed by the projection lens of a luminous unit of the luminous module. Alternatively, as will be described in detail below with reference to FIG. 7, each luminous unit of the luminous module 10 may comprise a projection mirror instead of the projection lens. Each portion 4a, 4b, 4c of the optical projection unit 4 may then be formed by the projection mirror of a luminous unit of the luminous module.

The mask 2 is configured to at least partially house the luminous module 10. This mask 2 has an opening 7 which covers the projection unit 4, and the luminous module is configured to direct the light rays emitted in the direction of this opening 7.

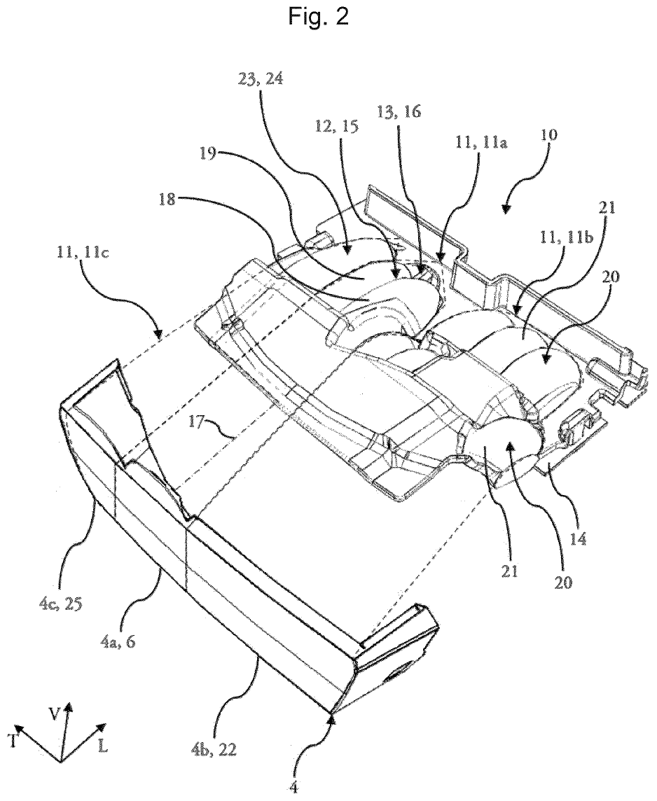

FIG. 2 shows the luminous module 10 from FIG. 1, from which the mask 2 has been removed. The luminous module 10 comprises at least one luminous unit according to the invention.

In particular, the luminous module 10 comprises a plurality of luminous units 11. Each of the luminous units comprises at least one light source, at least one collector, and an optical projection system.

In the example in FIG. 2, as explained above, the optical projection system of each luminous unit 11 is formed by a projection lens 6, 22, 25. Each projection lens 6, 22, 25 forms in this case one of the portions 4a, 4b, 4c of the projection unit 4.

Alternatively, and as shown in FIG. 7, the optical projection system of each luminous unit 11 may be formed by a projection mirror 6′, 22′, 25′. Each projection mirror 6′, 22′, 25′ then forms one of the portions 4a, 4b, 4c of the projection unit 4.

It will be noted that FIG. 7 is only intended to illustrate an embodiment variant of a luminous module 10 according to the invention, in which the optical projection unit of the luminous units 11 is formed by a projection mirror. Thus, except for the optical projection system, the luminous module shown in FIG. 7 is identical to the luminous module 10 shown in FIGS. 1 to 6. All the features described with reference to FIGS. 1 to 6 therefore apply, mutatis mutandis, to the luminous module illustrated in FIG. 7, except that the features described for the projection lens apply to the projection mirror. In particular, the features that relate to the position of the focus of the projection lenses apply to the position of the focus of the projection mirrors.

More particularly, in FIGS. 2 and 7, the luminous module 10 comprises a first luminous unit 11a, a second luminous unit 11b and a third luminous unit 11c. In FIGS. 2 and 7, the three luminous units 11 are delimited by dashed lines to make it easier for the reader to understand.

The first luminous unit 11a is the luminous unit 11 according to the invention. This comprises a first luminous subassembly 12 and a second luminous subassembly 13. Each luminous subassembly 12, 13 of the first luminous unit 11a comprises a light source and a collector. In addition, each of the luminous subassemblies 12, 13 at least partially carries out a lighting function inherent thereto within the luminous module 10. The latter can thus execute a plurality of lighting functions in as compact a way as possible.

In FIGS. 2 and 7, the light sources are not visible. These are connected to at least one printed circuit board 14. The luminous module 10 may comprise a single printed circuit board 14 bearing all of the light sources, and in particular the light sources of each luminous unit 11a, 11b, 11c, irrespective of the number of light sources. Alternatively, the luminous module 10 may comprise as many printed circuit boards 14 as there are luminous units 11.

Each of the light sources, when they are active in order to execute the lighting function in question, emits light rays in the direction of the collector that is inherent to each of the light sources. The collector or collectors has or have a reflective surface and a shape such that the light rays are collected and reflected in the direction of the projection unit 4, which projects each of said light rays in order to form a light beam corresponding to one or more lighting functions carried out by the luminous module 10.

In order to project the light beams resulting from the first luminous subassembly 12 and/or the second luminous subassembly 13, the first luminous unit 11a comprises a projection lens 6 incorporated into the projection unit 4. In FIG. 2, the projection lens 6 corresponds to the first portion 4a of the projection unit 4. The projection lens 6 is arranged so as to face the light rays emitted by the first luminous subassembly 12 and by the second luminous subassembly 13. The projection lens 6 is configured to have an optical axis 17 extending along a longitudinal direction L. In the example in FIG. 7, the first luminous unit 11a comprises a projection mirror 6′ incorporated into the projection unit 4.

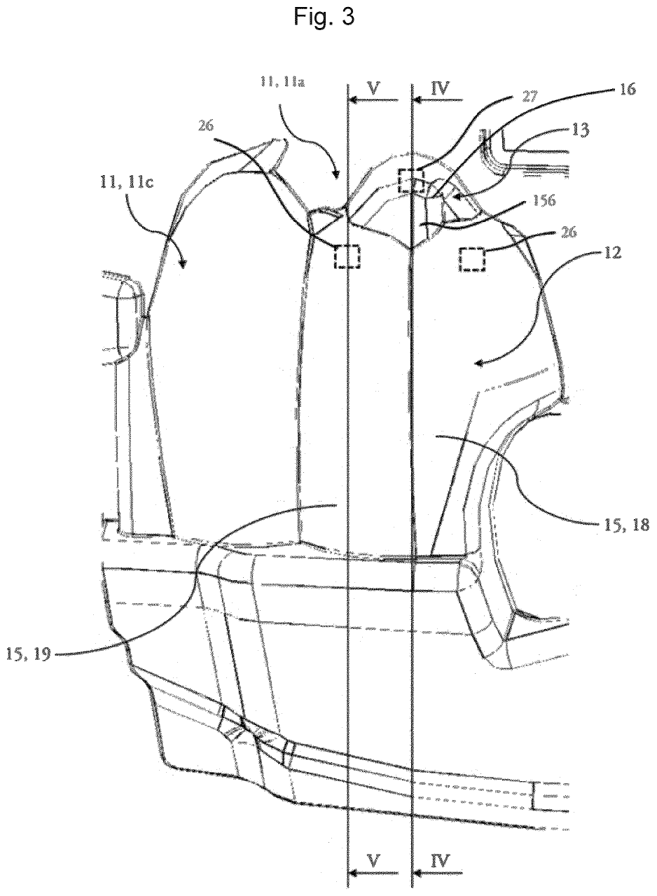

The first luminous subassembly 12 of the first luminous unit 11a comprises at least a first light source 26, visible in FIG. 3, and a first collector 15, while the second luminous subassembly 13 comprises a second light source 27, visible in FIG. 3, and a second collector 16. Each of the collectors 15, 16 has the function of collecting and reflecting the light rays emitted by the light source that is inherent thereto. As is shown in FIGS. 2 and 7, the first collector 15 and the second collector 16 exhibit an offset with respect to one another, at least along the longitudinal direction L, with the second collector 16 being arranged behind the first collector 15. In other words, a distance between the projection lens 6 (or the projection mirror 6′) and the second collector 16 is therefore greater than a distance between the projection lens 6 (or the projection mirror 6′) and the first collector 15. The positioning of the collectors of the first luminous unit 11a with respect to one another will be described in detail below.

Each collector may be divided into one or more reflective cavities. Multiplying the number of reflective cavities within a single collector, and therefore within a single luminous subassembly, helps for example to enhance the intensity and/or the extent along one or more given directions of the light beam formed on exiting said luminous subassembly. In FIGS. 2 and 7, the first collector 15 is divided into a first reflective cavity 18 and into a second reflective cavity 19, which are offset with respect to one another along a transverse direction T, perpendicular to the longitudinal direction L.

The two reflective cavities 18, 19 thus form a single collector. Therefore, both of them collect and reflect light rays intended to execute one and the same lighting function. To this end, the projection lens 6 (or the projection mirror 6′), that is to say the first portion 4a of the projection unit 4, faces all of the reflective cavities of the collectors of the first luminous unit 11a.

The reflective surface of the first collector 15, and in particular the reflective cavities 18, 19 of the first collector 15, and/or the reflective surface of the second collector 16, advantageously have a profile of the elliptical or parabolic type. According to one variant, the reflective surfaces form a surface of revolution about an axis parallel to the optical axis 17. This axis parallel to the optical axis 17 may in particular correspond to the optical axis of the collector.

As was mentioned above, the luminous module 10 illustrated in FIGS. 2 and 7 comprises three luminous units 11. Thus, the second luminous unit 11b and the third luminous unit 11c also comprise one or more luminous subassemblies, the lighting functions of which, which result therefrom, differ or may differ from the lighting functions executed by the first luminous subassembly 12 and by the second luminous subassembly 13 of the first luminous unit 11a.

It is therefore possible to observe that the second luminous unit 11b comprises at least one additional luminous subassembly 20 provided with one or more additional light sources and with one or more additional collectors 21, and an additional projection lens 22 in the example in FIG. 2, or an additional projection mirror 22′ in the example in FIG. 7. The additional luminous subassemblies 20 each at least partially execute a lighting function that is inherent thereto and are arranged so as to emit and reflect light rays to the additional projection lens 22 in the example in FIG. 2, or to the additional projection mirror 22′ in the example in FIG. 7, corresponding to the second portion 4b of the projection unit 4.

For its part, the third luminous unit 11c comprises an additional luminous subassembly 23 provided with an additional light source and an additional collector 24, and an additional projection lens 25 in the example in FIG. 2, or an additional projection mirror 25′ in the example in FIG. 7. The light rays emitted and reflected by the additional luminous subassembly 23 are subsequently projected by the additional projection lens 25 in the example in FIG. 2, or the additional projection mirror 25′ in the example in FIG. 7, corresponding to the third portion 4c of the projection unit 4.

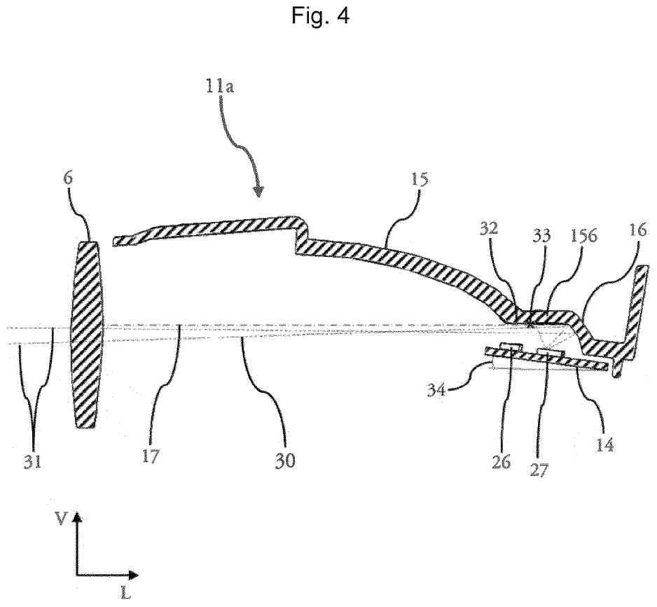

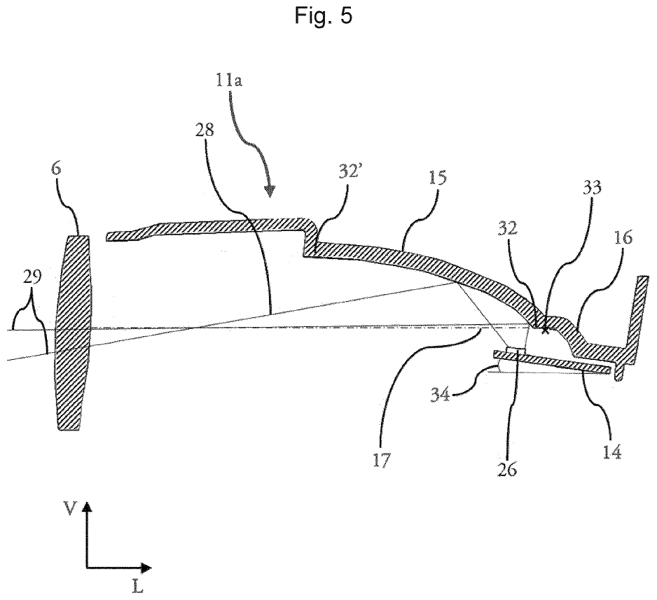

FIG. 4 and FIG. 5 are views in cross section of a luminous unit 11 according to the invention, in this case the first luminous unit 11a from FIG. 3. The cross section in FIG. 4 is on a plane IV-IV that is visible in FIG. 3 and defined by the longitudinal direction L and a vertical direction V perpendicular to the longitudinal direction L and to the transverse direction T, and the cross section in FIG. 5 is on a plane V-V that is also visible in FIG. 3 and is offset transversely with respect to the section plane of FIG. 4. The cross section in FIG. 4 passes through the second light source 27 associated with the second collector 16, while the cross section in FIG. 5 passes through a first light source 26 associated with the first collector 15.

FIG. 4 and FIG. 5 make it possible to see the printed circuit board 14, and some of the light sources that it bears, FIG. 4 showing in particular a first light source 26 disposed next to the first collector 15 and the second light source 27 disposed next to the second collector 16, as mentioned above, while FIG. 5 shows this first light source 26 disposed next to the first collector 15.

Each of the light sources 26, 27 is activated when the function associated with the luminous subassembly in question needs to be implemented. The activation and/or the deactivation of one or the other of the light sources 26, 27 may be effected manually by the driver of the vehicle, or automatically for example on the basis of data measured by a light detector (not shown).

In the view in FIG. 5, the propagation of light rays in the assembly formed by the first light source 26 and by the first collector 15 is illustrated in particular. The first light source 26, when activated, emits first light rays 28 which propagate to the reflective surface of the first collector 15 and are collected and reflected by said surface. The propagation of the reflected first light rays 28 takes place as far as the projection lens 6, which projects them in order to form a first light beam 29. In the view in FIG. 4, similarly, the propagation of light rays in the assembly formed by the second light source 27 and by the second collector 16 is illustrated in particular. The second light source 27 which emits second light rays 30 which are reflected by the reflective surface of the second collector 16 and propagate to the projection lens 6 and form a second light beam 31 on exiting said lens.

Each light source 26, 27 is disposed at a focus of the reflective surface of the corresponding collector, such that the rays that it emits are collected and reflected along the optical axis 17.

As mentioned above, the first collector 15 and the second collector 16 are offset with respect to one another along the longitudinal direction L. The first collector 15 is thus farther forward than the second collector 16, considering the main direction of propagation of the rays within the first luminous unit 11a, meaning that the first reflective surface of the first collector 15 is closer to the projection lens 6 than the second reflective surface of the second collector 16 is.

The two collectors 15, 16 are said to be juxtaposed longitudinally inasmuch as a rear end edge 32 of the first collector 15 is disposed in the direct continuation of a front end edge of the second collector 16. The rear end edge 32 of the first collector 15 is the longitudinal end edge of the first collector 15 which is farthest away from the projection lens 6.

As can be seen in FIGS. 2 and 3, the rear end edge 32 may have a curved profile in a longitudinal and transverse plane, this implying variations in distance between this rear end edge and the projection lens 6. FIG. 4 shows the assembly formed by the first collector 15 and the second collector 16 in a view in cross section on the plane IV-IV mentioned above, this section plane IV-IV passing through a point at which the rear end edge 32 is closest to the projection lens 6 and passing through a light source 27 associated with the second collector 16, the light source associated with the first collector therefore not being visible, while FIG. 5 shows the same assembly formed by the first collector 15 and the second collector 16 in a view in cross section on the plane V-V mentioned above, this section plane V-V passing through the point at which the rear end edge 32 is farthest away from the projection lens 6 and passing through the light source 26 associated with the first collector 15. In order make it easier to understand, the light sources have been depicted by way of dashed lines in FIG. 3, which also shows the section axes of FIGS. 4 and 5, in order to chart their respective positions with respect to one another, in particular their longitudinal and transverse offset, and their position with respect to the collector with which they are associated.

Where appropriate, as can be seen in FIG. 4 in particular, a platform 156 connects the rear end edge 32 of the first collector 15 to the front end edge of the second collector 16. This platform 156 makes it possible prevent light leaking between the first collector 15 and the second collector 16 in the region in which the rear end edge is closer to the projection lens. Moreover, it allows the rays coming from the second collector 16 to be reflected again. The rays coming from the second collector 16 that are then reflected by this platform 156 overlap the first light beam 29, thereby creating a more uniform transition between the first light beam 29 and the second light beam 31.

According to the invention, the two collectors 15, 16 are thus juxtaposed and offset at least longitudinally, with the first collector 15 which is closer to the projection lens 6 than the second collector 16, and the projection lens 6 is configured such that an optical focus 33 of this projection lens is disposed longitudinally between the two collectors 15, 16, or in other words behind the rear end edge 32 of the first collector 15 with respect to the main direction of propagation of the light rays along the optical axis. In other words again, the optical focus 33 of the projection lens 6 is at a distance from the latter that is greater than or equal to the distance between the projection lens 6 and the rear end edge 32 of the first collector 15.

In the example in FIG. 7, it will be understood that it is the focus of the projection mirror 6′ that is disposed longitudinally between the two collectors 15, 16.

The optical focus 33 is said to be in the vicinity of the rear end edge of the first collector in that the distance between this rear end edge 32 and the optical focus 33 is less than or equal to 10 mm.

As a result of this disposition, at least some of these reflected rays have angles of inclination in a vertical plane with respect to said optical axis 17 that are less than or equal to 25°, preferably less than or equal to 10°, so as to be under what are referred to as Gaussian conditions, making it possible to obtain a stigmatism, that is to say sharpness of the projected image. The rays are advantageously rays reflected by the rear part of the reflective surface of each of the collectors, and in particular rays reflected in the vicinity of the rear end edge 32 of the first collector 15.

This specific position of the optical focus 33 with respect to the rear end edge 32 of a collector, in a context in which two collectors are juxtaposed longitudinally one behind the other, makes it possible to improve the general sharpness and the uniformity of the projected image of the first light beam 29 and of the projected image of the second light beam 31.

Besides the offset along the longitudinal direction L between the first collector 15 and the second collector 16, the latter is also offset with respect to the first collector 15 along the vertical direction V, the second collector 16 being closer to the printed circuit board 14 than the first collector 15 is. This offset allows the propagation of the reflected second light rays 30 without these being obstructed by the first collector 15.

In the example illustrated, the printed circuit board 14 has an inclination with respect to a plane defined by the longitudinal direction L and the transverse direction. The printed circuit board 14 has an angle of inclination 34 of between 5° and 15° with respect to said plane. This inclination makes it possible to orient the first light source 26 and the second light source 27, respectively, further toward the curvature of the first collector 15 and of the second collector 16 in order to promote the reflection of the light rays.

As is visible in FIGS. 4 and 5, the first light beam 29 resulting from the first luminous subassembly is oriented below the optical axis, that is to say toward the road. This is a light beam associated with a lighting function that needs to be precise and sharp, in particular at its upper cutoff edge, formed by the imaging of the rear end edge 32. The front end edge 32′ of the first collector 15, that is to say the edge closest to the projection lens 6, delimits a lower part of the luminous image formed and projected onto the road, and the rear end edge 32 delimits an upper part of said image, when the luminous module 10 is oriented in a mounting position.

The second light beam 31 resulting from the second luminous subassembly is a light beam associated with a lighting function, at least a part of which is situated above the cutoff edge of the first light beam 29. The second light beam 31 may, for example, be superimposed on the first light beam 29 in order to form a light beam of the high beam type. Alternatively, the second light beam 31 may be an intensification of a light beam, for example at the center of this light beam, in order to form a light beam of the high beam type. Thus, the second light beam 31 does not require as much sharpness of the contours as the lighting function carried out by the first light beam 29. The position of the collectors 15, 16 with respect to one another and of the optical focus 33 with respect to the rear end edge 32, as have been described and illustrated, make it possible to provide a luminous unit 11a according to the invention, and a luminous module which combines compactness and achievement of a light beam for which the cutoff needs to be sharp, the positioning of the optical focus in the vicinity of the rear end edge making it possible to form a cutoff edge in a sharp manner by imaging of the rear end edge.

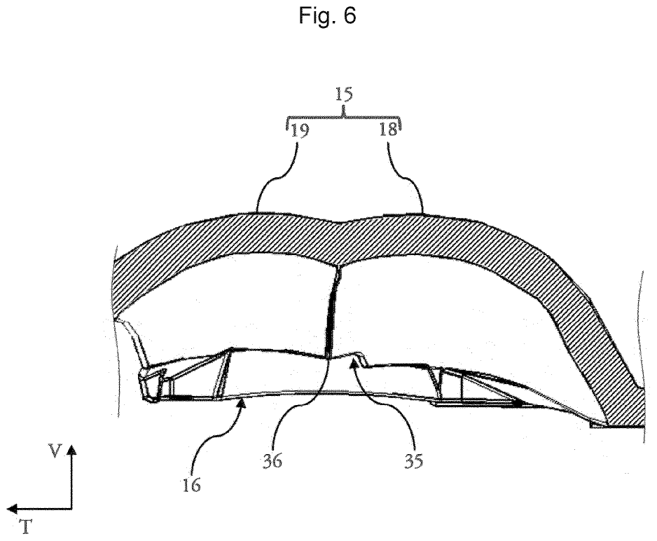

FIG. 6 is a cross section on a plane defined by the transverse direction T and by the vertical direction V of the first collector 15. It is thus possible to see the first collector 15 on the first plane and the second collector 16 behind the first collector 15. The offset along the vertical direction V between the first collector 15 and the second collector 16 is particularly visible in FIG. 5.

This figure makes particularly visible a specific shape of the rear end edge of the first collector 15, which in this case has a kink 35 extending mainly along the vertical direction V. The kink 35 makes it possible in particular to form a stepped upper cutoff edge of the first light beam by imaging.

Furthermore, the first reflective cavity 18 and the second reflective cavity 19 of the first collector 15 are joined together by a joining zone 36 which is parallel to the longitudinal direction and which may be aligned along the optical axis with respect to the vertical direction V.

Of course, the invention is not limited to the examples that have just been described, and numerous modifications may be made to these examples without departing from the scope of the invention.

The invention, as has just been described, clearly achieves its stated aim, and makes it possible to provide a luminous unit of a luminous module combining a plurality of lighting functions and combining compactness and uniformity of said lighting functions. Variants that are not described here may be implemented without departing from the context of the invention, provided that, in accordance with the invention, they comprise a luminous unit according to the invention.

What is claimed is:

1. A luminous unit of a luminous module of an automotive vehicle, comprising:
a first luminous subassembly includes at least a first light source configured to emit a plurality of first light rays and a first collector configured to collect and reflect the first light rays emitted by the first light source,
a second luminous subassembly includes at least a second light source configured to emit a plurality of second light rays and a second collector configured to collect and reflect the second light rays emitted by the second light source, and
an optical projection system configured to project the first light rays reflected by the first collector and the second light rays reflected by the second collector, the optical projection system includes an optical axis parallel to a longitudinal direction,
wherein the first collector and the second collector are offset with respect to one another at least along the longitudinal direction such that the first collector is arranged between the second collector and the optical projection system the first collector includes a rear end edge arranged between the optical projection system and an optical focus of the optical projection system.

2. The luminous unit as claimed in claim 1, wherein the optical projection system is formed by a projection lens.

3. The luminous unit as claimed in claim 1, wherein the rear end edge of the first collector is in contact with a front end edge of the second collector.

4. The luminous unit as claimed claim 1, wherein the optical focus of the optical projection system is disposed at a distance less than or equal to 10 mm from the rear end edge of the first collector.

5. The luminous unit as claimed claim 1, wherein the first collector and the second collector are offset with respect to one along a vertical direction perpendicular to the longitudinal direction.

6. The luminous unit as claimed in claim 5, wherein the optical axis of the optical projection system passes substantially through the rear end edge of the first collector and intersects the second collector.

7. The luminous unit as claimed in claim 1, further comprising a printed circuit board bearing all of the first and second light sources.

8. The luminous unit as claimed in claim 7, wherein the printed circuit board has an inclination of between 5° and 15° with respect to a plane perpendicular to a vertical direction.

9. The luminous unit as claimed in claim 8, wherein the first luminous subassembly is configured to cooperate with the optical projection system in order to generate a first light beam with a cutoff edge formed by the imaging of the rear end edge of the first collector, and the second luminous subassembly is configured to cooperate with the optical projection system in order to generate a second light beam different than the first light beam, at least a part of which is situated above the cutoff edge.

10. A luminous module of a vehicle, comprising at least a first luminous unit and a second luminous unit, the first luminous unit including a first luminous subassembly includes at least a first light source configured to emit a plurality of first light rays and a first collector configured to collect and reflect the first light rays emitted by the first light source, a second luminous subassembly includes at least a second light source configured to emit a plurality of second light rays and a second collector configured to collect and reflect the second light rays emitted by the second light source, and an optical projection system configured to project the first light rays reflected by the first collector and the second light rays reflected by the second collector, the optical projection system includes an optical axis parallel to a longitudinal direction, wherein the first collector and the second collector are offset with respect to one another at least along the longitudinal direction such that the first collector is arranged between the second collector and the optical projection system, the first collector includes a rear end edge arranged between the optical projection system and an optical focus of the optical projection system.

11. The luminous module as claimed in claim 10, wherein the second luminous unit includes at least one additional luminous subassembly and an additional optical projection system.
